(19) United States
(12) Patent Application Publication
(10) Pub. No.: US 2014/0009413 A1
(43) Pub. Date: Jan. 9, 2014

(54) PRESSURE-SENSING TOUCH METHOD AND TOUCH DISPLAY DEVICE THEREOF

(71) Applicant: WISTRON CORPORATION, New Taipei City (TW)

(72) Inventors: Pin-Hsien Su, New Taipei City (TW); Cheng-Lan Lee, New Taipei City (TW); Wen-Chin Wu, New Taipei City (TW)

(73) Assignee: WISTRON CORPORATION, New Taipei City (TW)

(21) Appl. No.: 13/854,153

(22) Filed: Apr. 1, 2013

(30) Foreign Application Priority Data
Jul. 9, 2012 (TW) 101124600

(51) Int. Cl. G06F 3/041

(52) U.S. Cl. CPC G06F 3/0414
USPC 345/173

(57) ABSTRACT

A pressure-sensing touch method is applied to a touch display device including a touch panel, a display panel, at least one pressure-sensing device, an analogy-to-digital converter and a processing unit. The pressure-sensing touch method includes performing a touch operation on the touch panel, the processing unit executing a first touch command on an operating interface displayed by the display panel according to the touch operation, the touch panel detecting a coordinate value corresponding to the touch operation, the pressure-sensing device detecting at least one pressure value corresponding to the coordinate value, the analogy-to-digital converter performing analogy-to-digital conversion on the pressure value detected by the pressure-sensing device, and the processing unit determining whether to execute a second touch command according to the coordinate value and the pressure value detected by the pressure-sensing device.

### BACKGROUND OF THE INVENTION

1. Field of the Invention

The present invention relates to a pressure-sensing touch method and a touch display device thereof, and more specifically, to a pressure-sensing touch method for executing a further touch command according to a pressure value detected by a pressure-sensing device and a touch display device thereof.

2. Description of the Prior Art

With development of touch technology, a conventional mobile electronic product (e.g. a smart phone, a tablet computer, and a digital camera) usually has a touch function, and related touch commands are usually executed by performing a click operation or a slide operation on a touch panel of the mobile electronic product, such as clicking a function icon to execute a corresponding function or scrolling an image displayed on the mobile electronic product by performing a downward-slide operation on the touch panel. However, if a user wants to trigger a further touch command (e.g. opening a function menu or executing a quick scroll command), the user needs to press the touch panel over a period of time, so as to cause a time-consuming touch operation and make the touch operation of the mobile electronic product not intuitive and convenient.

### SUMMARY OF THE INVENTION

An objective of the present invention is to provide a pressure-sensing touch method for executing a further touch command according to a pressure value detected by a pressure-sensing device and a touch display device thereof.

The present invention provides a pressure-sensing touch method applied to a touch display device. The touch display device includes a touch panel, a display panel, a pressure-sensing device, an analogy-to-digital converter and a processing unit. The touch panel is disposed on the display panel. The pressure-sensing device is disposed at a position corresponding to at least one side of the touch panel. The display panel is used for displaying an operating interface. The analogy-to-digital converter is electrically connected to the pressure-sensing device. The processing unit is electrically connected to the touch panel, the display panel, and the analogy-to-digital converter. The pressure-sensing touch method includes performing a touch operation on the touch panel, the processing unit executing a first touch command on an operating interface according to the touch operation, the touch panel detecting a coordinate value corresponding to the touch operation, the pressure-sensing device detecting at least one pressure value corresponding to the coordinate value on the touch panel, the analogy-to-digital converter performing analogy-to-digital conversion on the pressure value detected by the pressure-sensing device, and the processing unit determining whether to execute a second touch command according to the coordinate value and the pressure value detected by the pressure-sensing device.

According to the claimed invention, the pressure-sensing device includes four pressure-sensing strips. Performing the touch operation on the touch panel includes performing a slide operation or a click operation on the touch panel. The processing unit determining whether to execute the second touch command according to the coordinate value and the pressure value detected by the pressure-sensing device includes the processing unit calculating a pressure average value according to the coordinate value and the pressure value detected by each pressure-sensing strip and the processing unit determining whether to execute the second touch command according to the pressure average value.

According to the claimed invention, performing the slide operation on the touch panel includes performing a one-point slide operation on the touch panel. The processing unit determining whether to execute the second touch command according to the pressure average value includes the processing unit executing an unlock command or a quick scroll command on the operating interface when the processing unit determines that the pressure average value is greater than or equal to a threshold value.

According to the claimed invention, the touch panel has a plurality of touch regions. When the touch region where the coordinate value is located is adjacent to one of the pressure-sensing strips, the pressure average value is calculated according to the following equation: the pressure average value=the pressure value detected by the adjacent pressure-sensing strip. When the touch region where the coordinate value is located is adjacent to two of the pressure-sensing strips, the pressure average value is calculated according to the following equation: the pressure average value=(the sum of the two pressure value detected by the two adjacent pressure-sensing strips)/2. When the touch region where the coordinate value is located is not adjacent to the pressure-sensing strips, the pressure average value is calculated according to the following equation: the pressure average value=(the sum of the pressure value detected by each pressure-sensing strip)/4.

According to the claimed invention, the pressure-sensing touch further includes the processing unit controlling the display device to display a tooltip indicating a measure of the pressure average value on the operating interface.

According to the claimed invention, performing the slide operation on the touch panel includes performing a two-point slide operation on the touch panel to select a specific region. When the processing unit determines the pressure average value is greater than or equal to a threshold value, the processing unit executes a quick zoom-in command, a quick zoom-out command, a copy command, or a mark command corresponding to the specific region on the operating interface.

According to the claimed invention, the operating interface has a function icon. Performing the click operation on the touch panel includes clicking the function icon on the touch panel. When the processing unit determines the pressure average value is greater than or equal to a threshold value, the processing unit executes a menu display command or an icon processing command corresponding to the function icon on the operating interface.

According to the claimed invention, the icon processing command includes an icon dragging command or an icon deleting command.

According to the claimed invention, the operating interface has a folder icon. Performing the click command on the touch panel includes clicking the folder icon on the touch panel. When the processing unit determines the pressure average value is greater than or equal to a threshold value, the processing unit executes a directory expanding command corresponding to the folder icon on the operating interface.

According to the claimed invention, the pressure-sensing device includes a pressure-sensing strip. Performing the touch operation on the touch panel includes performing a slide operation or a click operation. The processing unit determining whether to execute the second touch command according to the coordinate value and the pressure value detected by the pressure-sensing device includes the processing unit determining whether to execute the second touch command according to the coordinate value and the pressure value detected by the pressure-sensing strip.

According to the claimed invention, performing the slide operation on the touch panel includes performing a one-point slide operation on the touch panel. The processing unit determining whether to execute the second touch command according to the coordinate value and the pressure value includes the processing unit executing an unlock command or a quick scroll command on the operating interface when the processing unit determines that the pressure value is greater than or equal to a threshold value.

According to the claimed invention, the pressure-sensing touch method further includes the processing unit controlling the display device to display a tooltip indicating a measure of the pressure value on the operating interface.

According to the claimed invention, performing the slide operation on the touch panel includes performing a two-point slide operation on the touch panel to select a specific region. When the processing unit determines the pressure value is greater than or equal to a threshold value, the processing unit executes a quick zoom-in command, a quick zoom-out command, a copy command, or a mark command corresponding to the specific region on the operating interface.

According to the claimed invention, the operating interface has a function icon. Performing the click operation on the touch panel includes clicking the function icon on the touch panel. When the processing unit determines the pressure value is greater than or equal to a threshold value, the processing unit executes a menu display command or an icon processing command corresponding to the function icon on the operating interface.

According to the claimed invention, the operating interface has a folder icon. Performing the click command on the touch panel includes clicking the folder icon on the touch panel. When the processing unit determines the pressure value is greater than or equal to a threshold value, the processing unit executes a directory expanding command corresponding to the folder icon on the operating interface.

The present invention further provides a touch display device including a display panel, a touch panel, a pressure-sensing device, an analogy-to-digital converter, a processing unit, and a storage unit. The display panel is used for displaying an operating interface of an operating system. The touch panel is disposed on the display panel for detecting a coordinate value corresponding to a touch operation. The pressure-sensing device is disposed at a position corresponding to at least one side of the touch panel for detecting at least one pressure value corresponding to the coordinate value on the touch panel. The analogy-to-digital converter is electrically connected to the pressure-sensing device for performing analogy-to-digital conversion on the pressure value detected by the pressure-sensing device. The processing unit is electrically connected to the touch panel, the display panel, and the analogy-to-digital converter for executing a first touch command on the operating interface and for determining whether to execute a second touch command according to the coordinate value and the pressure value detected by the pressure-sensing device. The storage unit is electrically connected to the processing unit for storing the operating system and the pressure value detected by the pressure-sensing device.

According to the claimed invention, the pressure-sensing device includes four pressure-sensing strips respectively disposed at positions corresponding to four sides of the touch panel. The touch operation includes a slide operation or a click operation. The processing unit is used for calculating a pressure average value according to the coordinate value and the pressure value detected by each pressure-sensing strip and for determining whether to execute the second touch command according to the pressure average value.

According to the claimed invention, the slide operation includes a one-point slide operation. The processing unit is used for controlling the operating system to call a corresponding application program interface so as to execute an unlock command or a quick scroll command on the operating interface when the processing unit determines that the pressure average value is greater than or equal to a threshold value.

According to the claimed invention, the processing unit is further used for controlling the operating system to call a corresponding application program interface so that the display device could display a tooltip indicating a measure of the pressure average value on the operating interface.

According to the claimed invention, the slide operation comprises a two-point slide operation to select a specific region on the touch panel. When the processing unit determines the pressure average value is greater than or equal to a threshold value, the processing unit is used for controlling the operating system to call a corresponding application program interface so as to execute a quick zoom-in command, a quick zoom-out command, a copy command, or a mark command corresponding to the specific region on the operating interface.

According to the claimed invention, the operating interface has a function icon. The click operation includes clicking the function icon on the touch panel. When the processing unit determines the pressure average value is greater than or equal to a threshold value, the processing unit is used for controlling the operating system to call a corresponding application program interface so as to execute a menu display command or an icon processing command corresponding to the function icon on the operating interface.

According to the claimed invention, the operating interface has a folder icon. The click command includes clicking the folder icon on the touch panel. When the processing unit determines the pressure average value is greater than or equal to a threshold value, the processing unit is used for controlling the operating system to call a corresponding application program interface so as to execute a directory expanding command corresponding to the folder icon on the operating interface.

According to the claimed invention, the pressure-sensing device includes a pressure-sensing strip. The touch operation includes a slide operation or a click operation. The processing unit is used for determining whether to execute the second touch command according to the coordinate value and the pressure value detected by the pressure-sensing strip.

According to the claimed invention, the slide operation includes a one-point slide operation on the touch panel. When the processing unit determines that the pressure value is greater than or equal to a threshold value, the processing unit is used for controlling the operating system to call a corresponding application program interface so as to execute an unlock command or a quick scroll command on the operating interface.

According to the claimed invention, the processing unit is further used for controlling the operating system to call a corresponding application program so that the display device could display a tooltip indicating a measure of the pressure value on the operating interface.

According to the claimed invention, the slide operation includes a two-point slide operation to select a specific region on the touch panel. When the processing unit determines the pressure value is greater than or equal to a threshold value, the processing unit is used for controlling the operating system to call a corresponding application program interface so as to execute a quick zoom-in command, a quick zoom-out command, a copy command, or a mark command corresponding to the specific region on the operating interface.

According to the claimed invention, the operating interface has a function icon. The click operation includes clicking the function icon on the touch panel. When the processing unit determines the pressure value is greater than or equal to a threshold value, the processing unit is used for controlling the operating system to call a corresponding application program interface so as to execute a menu display command or an icon processing command corresponding to the function icon on the operating interface.

According to the claimed invention, the operating interface has a folder icon. The click command includes clicking the folder icon on the touch panel. When the processing unit determines the pressure value is greater than or equal to a threshold value, the processing unit is used for controlling the operating system to call a corresponding application program interface so as to execute a directory expanding command corresponding to the folder icon on the operating interface.

In summary, the present invention utilizes the design of executing a further touch command according to the pressure value detected by the pressure-sensing device to replace the prior art design in which a user needs to press the touch panel over a period of time for executing a further touch command. In such a manner, the present invention could not only reduce time needed for performing touch operations on the touch panel of the touch display device, but also make the touch operations of the touch display device more intuitive and convenient.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a touch display device according to an embodiment of the present invention.

FIG. 2 is a partial sectional diagram of the touch display device in FIG. 1 along a sectional line 1-1′.

FIG. 3 is a functional block diagram of the touch display device in FIG. 1.

FIG. 4 is a flowchart of a pressure-sensing touch method according to an embodiment of the present invention.

FIG. 5 is a diagram of an unlock operation being performed on a touch panel in FIG. 1.

FIG. 6 is a diagram of the touch panel and four pressure-sensing strips in FIG. 1.

FIG. 7 is a diagram of performing a scroll operation on the touch panel in FIG. 1 according to another embodiment of the present invention.

FIG. 8 is a diagram of performing a zoom-in operation for a specific region on the touch panel in FIG. 1 according to another embodiment of the present invention.

FIG. 9 is a diagram of performing a region selecting operation for a specific region on the touch panel in FIG. 1 according to another embodiment of the present invention.

FIG. 10 is a diagram of performing a function-icon clicking operation on the touch panel in FIG. 1 according to another embodiment of the present invention.

FIG. 11 is a diagram of performing a function-icon clicking operation on the touch panel in FIG. 1 according to another embodiment of the present invention.

FIG. 12 is a diagram of performing a folder-icon clicking operation on the touch panel in FIG. 1 according to another embodiment of the present invention.

### DETAILED DESCRIPTION

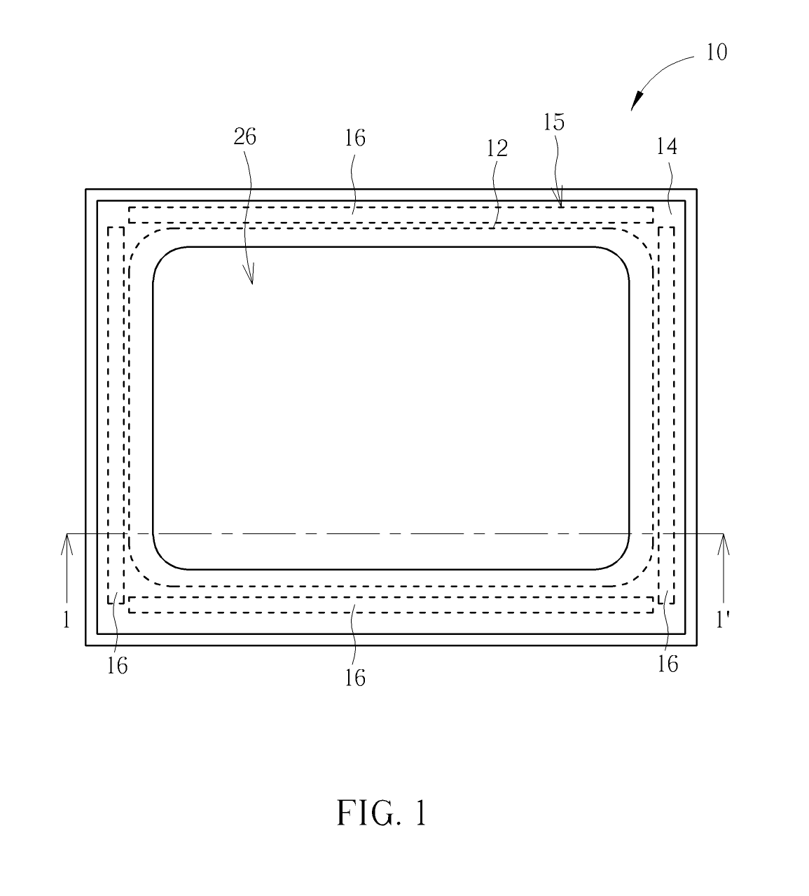

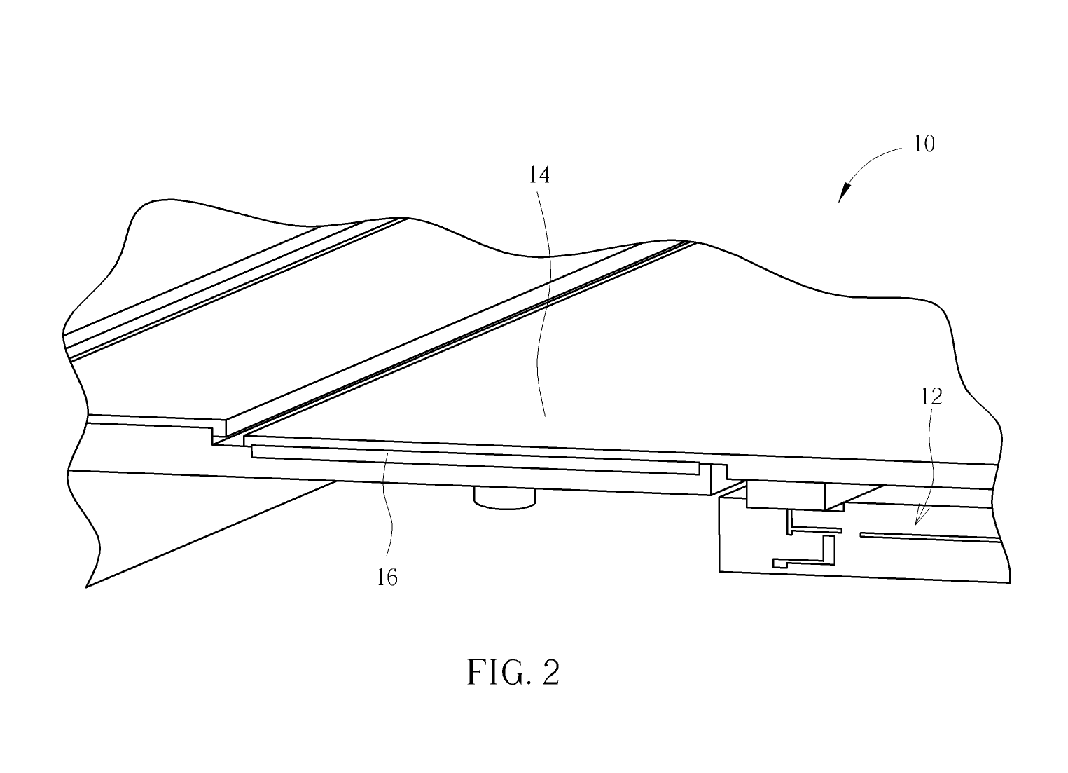

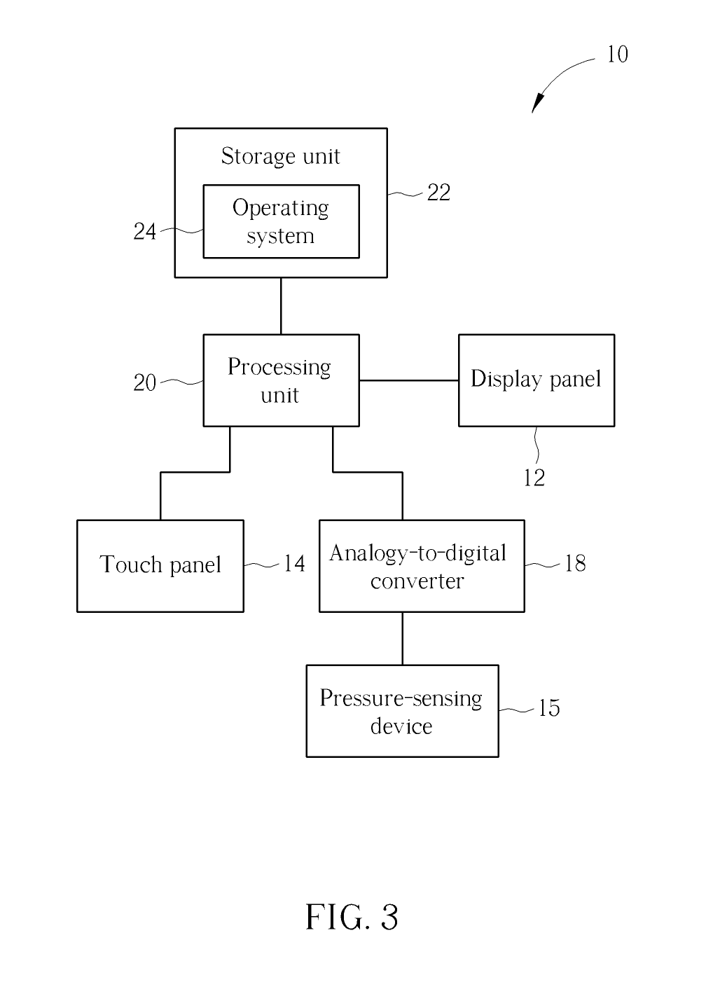

Please refer to FIG. 1, FIG. 2, and FIG. 3. FIG. 1 is a diagram of a touch display device 10 according to an embodiment of the present invention. FIG. 2 is a partial sectional diagram of the touch display device 10 in FIG. 1 along a sectional line 1-1′. FIG. 3 is a functional block diagram of the touch display device 10 in FIG. 1. The touch display device 10 could be a tablet computer, but not limited thereto, meaning that the touch display device 10 could also be other mobile electronic product having a touch function (e.g. a smart phone or a digital camera). As shown in FIGS. 1-3, the touch display device 10 includes a display panel 12, a touch panel 14, a pressure-sensing device 15, an analogy-to-digital converter 18, a processing unit 20, and a storage unit 22.

The display panel 12 is used for displaying an operating interface 26 of an operating system 24 (e.g. a desktop interface of a Windows operating system) for a user to operate. The touch panel 14 is disposed on the display panel 12 for detecting a coordinate value corresponding to a touch operation (e.g. clicking a function icon). The pressure-sensing device 15 is disposed at a position corresponding to at least one side of the touch panel 14. In this embodiment, the pressure-sensing device 15 could include four pressure-sensing strips 16 respectively disposed under the four sides of the touch panel 14 (as shown in FIG. 1). Each pressure-sensing strip 16 is used for detecting a pressure value corresponding to the aforesaid coordinate value. To be noted, the four pressure-sensing strips 16 are not limited to be disposed under the four sides of the touch panel 14, meaning that the four pressure-sensing strips 16 could also be disposed on other inner component of the touch display device 10 corresponding to the four sides of the touch panel 14. That is to say, all designs of utilizing the inner components of the touch display device 10 to fix the four pressure-sensing strips 16 and then utilizing the four pressure-sensing strips 16 to detect the pressure that the touch panel 14 withstands may fall within the scope of the present invention. The analogy-to-digital converter 18 is electrically connected to each pressure-sensing strip 16 for performing analogy-to-digital conversion on the pressure value detected by each pressure-sensing strip 16. The processing unit 20 is electrically connected to the display panel 12, the touch panel 14, and the analogy-to-digital converter 18 for executing a corresponding touch command on the operating interface 26 according to the aforesaid touch operation and for executing a corresponding touch command according to the aforesaid coordinate value and the pressure value detected by each pressure-sensing strip 16. The storage unit 22 is electrically connected to the processing unit 20 for storing the operating system 24 and the pressure value detected by each pressure-sensing strip 16.

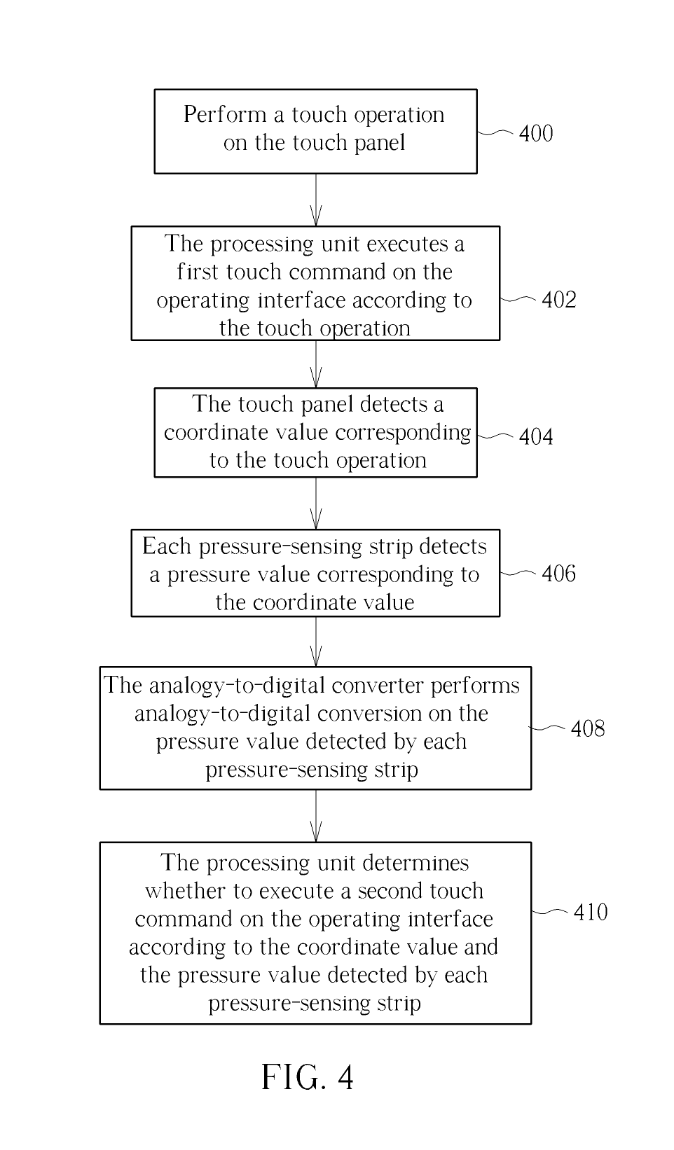

The pressure-sensing touch method according to the present invention is described as follows. Please refer to FIGS. 1-4. FIG. 4 is a flowchart of a pressure-sensing touch method according to an embodiment of the present invention. The pressure-sensing touch method includes the following steps.

Step 400: Perform a touch operation on the touch panel 14;

Step 402: The processing unit 20 executes a first touch command on the operating interface 26 according to the touch operation;

Step 404: The touch panel 14 detects a coordinate value corresponding to the touch operation;

Step 406: Each pressure-sensing strip 16 detects a pressure value corresponding to the coordinate value;

Step 408: The analogy-to-digital converter 18 performs analogy-to-digital conversion on the pressure value detected by each pressure-sensing strip 16;

Step 410: The processing unit 20 determines whether to execute a second touch command on the operating interface 26 according to the coordinate value and the pressure value detected by each pressure-sensing strip 16.

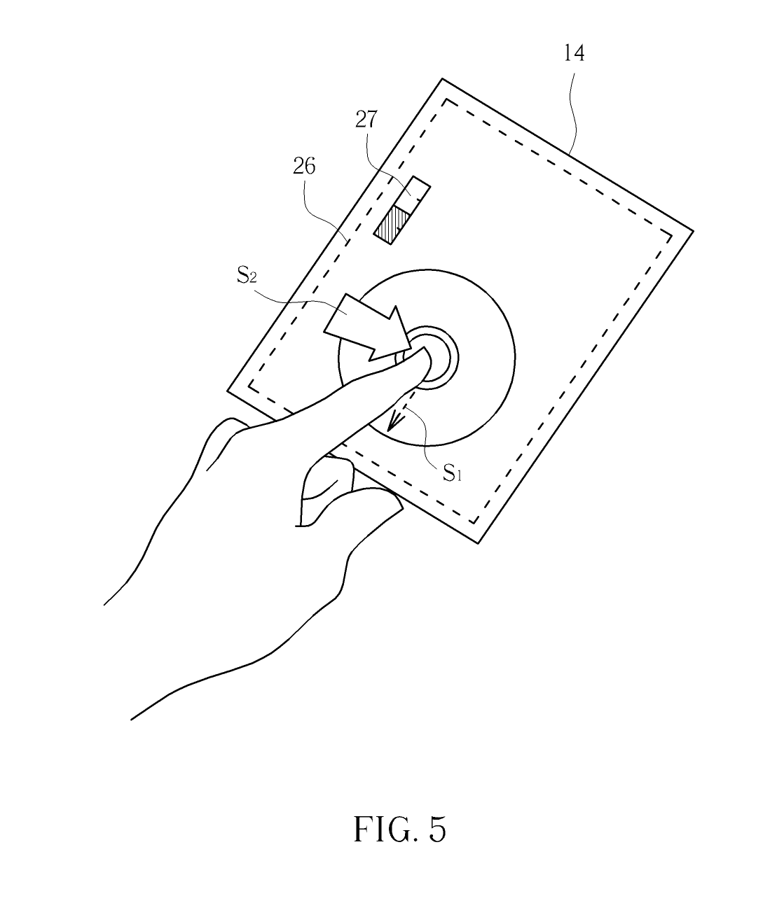

More detailed description for the aforesaid steps is provided as follows on premise that the second touch command is an unlock command. Please refer to FIG. 4 and FIG. 5. FIG. 5 is a diagram of an unlock operation being performed on the touch panel 14 in FIG. 1. In Step 400, when a user wants to perform an unlock operation on the touch panel 14, the user just needs to touch the touch panel 14 and then perform a one-point slide operation along a slide direction S₁ over a distance (i.e. the touch operation as shown in FIG. 4). At this time, the processing unit 20 could execute the first touch command on the operating interface 26 (Step 402) according to a touch signal transmitted from the touch panel 14. In this embodiment, the first touch command could be regarded as a dragging command. To be noted, the aforesaid slide direction on the touch pane 14 is not limited to the slide direction S₁, meaning the aforesaid touch operation could also be performed along other slide direction (e.g. an upward direction, a leftward direction, or an oblique direction).

After the aforesaid one-point slide operation is completed, the touch panel 14 could detect the coordinate value corresponding to the aforesaid one-point slide operation (Step 404) as a reference for the subsequent pressure calculation of the processing unit 20. The aforesaid coordinate value could be a coordinate value of a slide destination of the aforesaid one-point slide operation. Subsequently, the user could exert force upon the touch panel 14 along a direction S₂ (as shown in FIG. 5). At this time, each pressure-sensing strip 16 could detect the pressure value corresponding to the coordinate value (Step 406), and then the analogy-to-digital converter 18 could transmit the detected pressure values back to the processing unit 20 after performing analogy-to-digital conversion on the pressure value detected by each pressure-sensing strip 16 (Step 408). Finally, the processing unit 20 could determine whether to execute the second touch command on the operating interface 26, which is the unlock command for unlocking the operating interface 26, according to the coordinate value and the pressure value detected by each pressure-sensing strip 16 (Step 410).

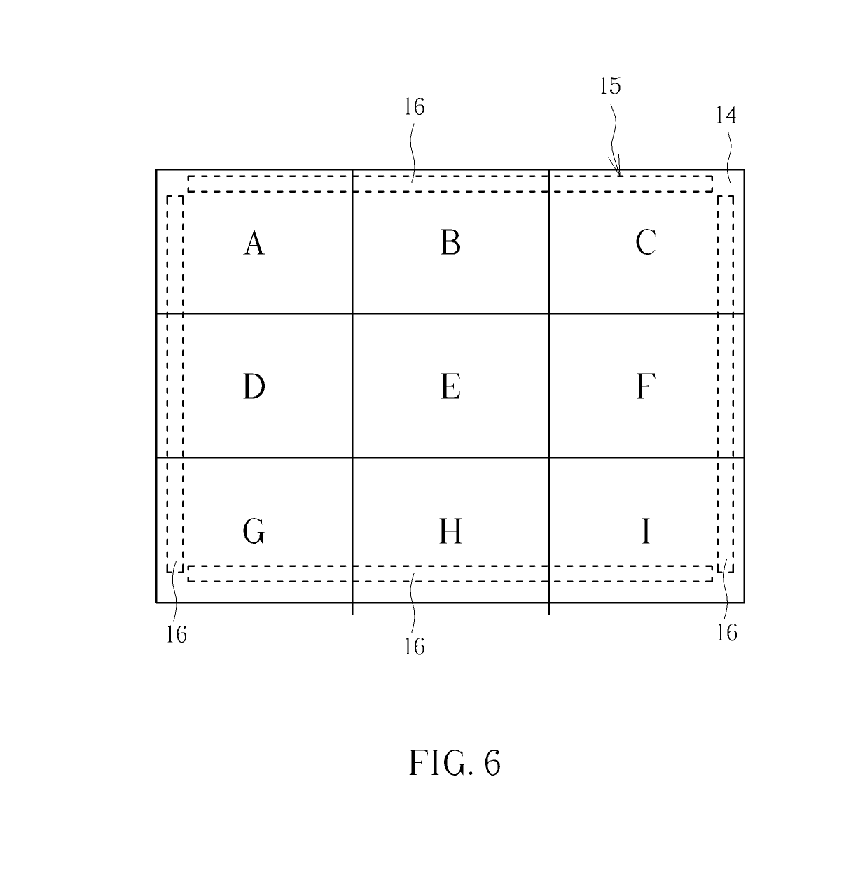

To be more specific, in this embodiment, the processing unit 20 could compare the pressure average value of the aforesaid pressure values with a threshold value (could be a predetermined value set in the processing unit 20 or be set manually by the user himself) for determining whether to execute the second touch command. Please refer to FIG. 6, which is a diagram of the touch panel 14 and the four pressure-sensing strips 16 in FIG. 1. As shown in FIG. 6, in this embodiment, the touch panel 14 could have nine touch regions A, B, C, D, E, F, G, H, I (but not limited thereto), and the processing unit 20 could calculate a pressure average value according to the coordinate value detected by the touch panel 14 and the pressure value detected by each pressure-sensing strip 16 and then determine whether to execute the second touch command on the operating interface 26 according to a comparison result of whether the pressure average value is greater than or equal to the threshold value. That is to say, if the processing unit 20 determines that the pressure average value is greater than or equal to the threshold value, the processing unit 20 could control the operating system 24 to call a corresponding application program interface so as to execute an unlock command on the operating interface 26. As for the related program library design for the aforesaid application program interface and the unlock command, it is commonly seen in the prior art and therefore omitted herein.

In this embodiment, the related equations for calculating the aforesaid the pressure average value are described as follows. When the touch region where the coordinate value detected by the touch panel 14 is located is only adjacent to one of the four pressure-sensing strips 16, the pressure average value could be equal to the pressure value detected by this adjacent pressure-sensing strip 16. When the touch region where the coordinate value detected by the touch panel 14 is located is only adjacent to two of the four pressure-sensing strips 16, the processing unit 20 could divide the sum of the two pressure values detected by the two adjacent pressure-sensing strips 16 by 2 to calculate the pressure average value. When the touch region where the coordinate value detected by the touch panel 14 is located is not adjacent to the four pressure-sensing strips 16, the processing unit 20 could divide the sum of the pressure value detected by each pressure-sensing strip 16 by 4 to calculate the pressure average value.

For example, it is assumed that the coordinate value detected by the touch panel 14 falls within one touch region corresponding to one side of the touch panel 14 (i.e. the touch region B, C, F, or H) after the user performs the aforesaid downward-slide operation on the touch panel 14. In the following, detailed description for calculation of the aforesaid pressure average value is provided on premise that the coordinate value detected by the touch panel 14 falls within the touch region B. As for the related description for calculation of the aforesaid pressure average value if the coordinate value detected by the touch panel 14 falls within other touch region (i.e. the touch region D, F, or H), it could be reasoned by analogy. As shown in FIG. 6, since the touch region B is only adjacent to the pressure-sensing strip 16 located at the left side of the touch panel 14, the pressure average value could be equal to the pressure value detected by the pressure-sensing strip 16 located at the left side of the touch panel 14.

For another example, it is assumed that the coordinate value detected by the touch panel 14 falls within one of the touch regions corresponding to four corners of the touch panel 14 (i.e. the touch regions A, C, G, I) after the user performs the aforesaid downward-slide operation on the touch panel 14. In the following, detailed description for calculation of the aforesaid pressure average value is provided on premise that the coordinate value detected by the touch panel 14 falls within the touch region A. As for the related description for calculation of the aforesaid pressure average value if the coordinate value detected by the touch panel 14 falls within other touch region (i.e. the touch region C, G, or I), it could be reasoned by analogy. As shown in FIG. 6, since the touch region A is adjacent to the pressure-sensing strips 16 at the upper side and the left side of the touch panel 14, the processing unit 20 could divide the sum of the two pressure values detected by the two pressure-sensing strips 16 at the upper side and the left side of the touch panel 14 by 2 to calculate the pressure average value.

For another example, it is assumed that the coordinate value detected by the touch panel 14 falls within the touch region corresponding to the center of the touch panel 14 (i.e. the touch region E) after the user performs the aforesaid downward-slide operation on the touch panel 14. As shown in FIG. 6, since the touch region E is not adjacent to the four pressure-sensing strips 16, the processing unit could divide the sum of the pressure value detected by each pressure-sensing strip 16 by 4 to calculate the pressure average value.

To be noted, the touch display device 10 could also utilize other equation for calculating the pressure average value, such as averaging the weighted sum of the pressure value detected by each pressure-sensing strip 16.

Furthermore, for achieving the purpose that the user could clearly know a measure of the pressing force that he exerts on the touch panel 14, when the user presses the touch panel 14 along the direction S₂, the processing unit 20 could further control the operating system 24 to call a corresponding application program interface so that a tooltip 27 indicating a measure of the pressure average value could be accordingly displayed on the operating interface 26. Thus, via assistance of the tooltip 27, the user could exert a proper force on the touch panel 14 precisely to unlock the touch display device 10, so as to increase convenience of the touch display device 10 in use and prevent other user from unlocking the touch display device 10 easily.

The pressure-sensing touch method provided by the present invention is not limited to be applied to the aforesaid embodiment. In other words, all designs of executing a further touch command according to the pressure value detected by the pressure-sensing strip may fall within the scope of the present invention. For example, the touch display device 10 could utilize the aforesaid pressure-sensing touch method to execute a quick scroll command, or execute a quick zoom-in command, a quick zoom-out command, a copy command, or a mark command corresponding to a specific region. Furthermore, the touch display device 10 could also utilize the aforesaid pressure-sensing touch method to execute a menu display command or an icon processing command for a function icon, or execute a directory expanding command for a folder icon.

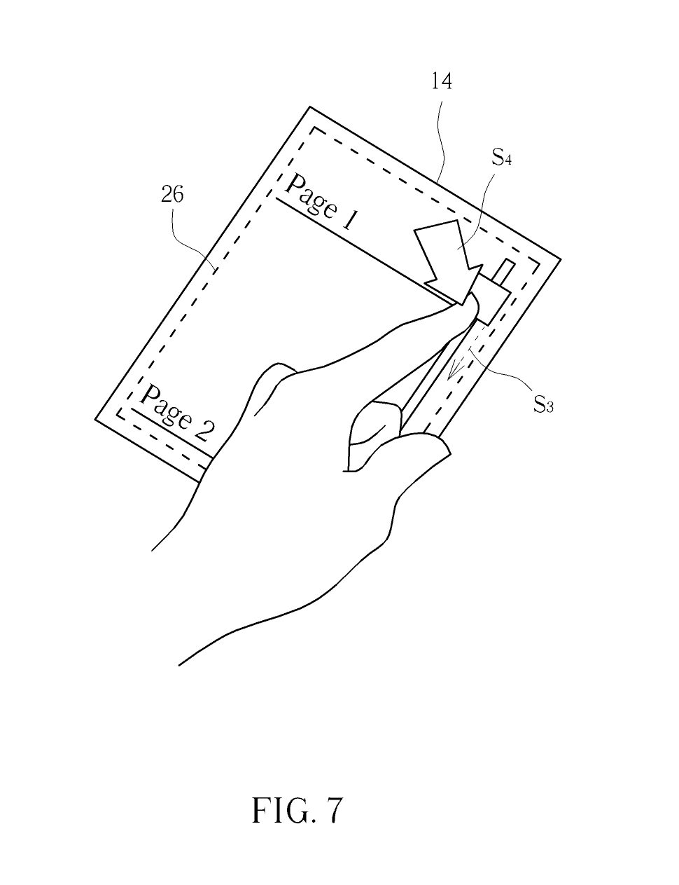

The design of utilizing the aforesaid pressure-sensing touch method to execute a quick scroll command is described as follows. Please refer to FIG. 7, which is a diagram of performing a scroll operation on the touch panel 14 in FIG. 1 according to another embodiment of the present invention. First, the user could touch the touch panel 14 and then perform a one-point slide operation along a direction S₃ over a distance, so as to execute a scroll command (could be regarded as the first touch command) on the operating interface 26. Subsequently, the user could exert force on the touch panel 14 along a direction S₄, so as to further execute a quick scroll command (could be regarded as the second touch command) on the operating interface 26. As for the pressure-value calculation of the processing unit 20 and the other related description, they could be reasoned according to the aforesaid embodiment and therefore omitted herein.

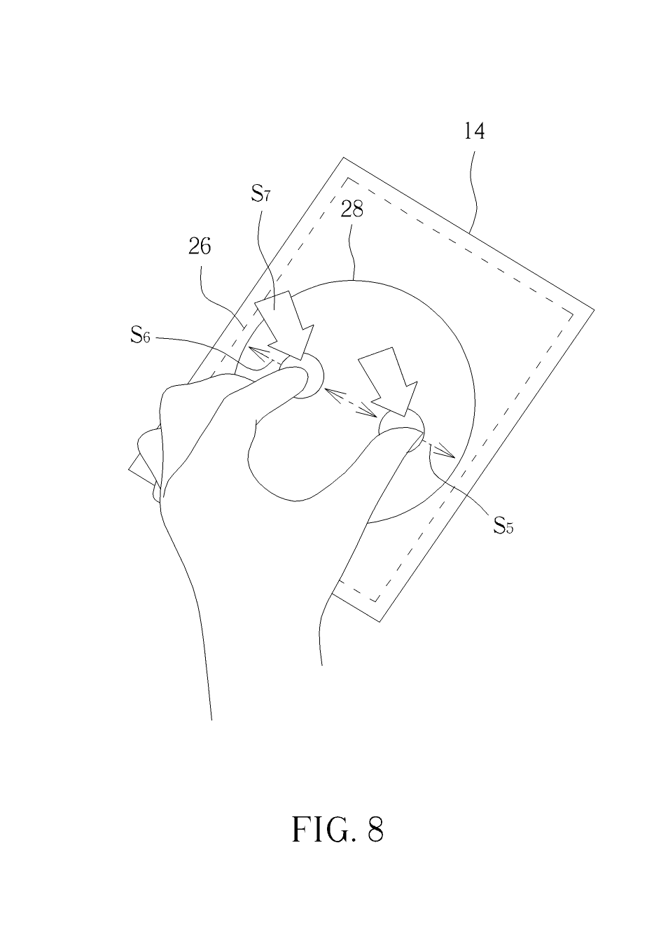

The design of utilizing the aforesaid pressure-sensing touch method to execute a quick zoom-in command or a quick zoom-out command for a specific region is described as follows. Please refer to FIG. 8, which is a diagram of performing a zoom-in operation for a specific region on the touch panel 14 in FIG. 1 according to another embodiment of the present invention. First, the user could touch two points of the touch panel 14 as shown in FIG. 8 and then perform a two-point outward slide operation along two directions S₅, S₆ to select a specific region 28, so as to execute a zoom-in command (could be regarded as the first touch command) on the operating interface 26. Subsequently, the user could exert force on the touch panel 14 along a direction S₇, so as to further execute a quick zoom-in command (could be regarded as the second touch command) for the specific region 28 on the operating interface 26. On the other hand, if the user performs a two-point inward slide operation along two directions opposite to the two directions S₅, S₆ instead and then exerts force on the touch panel 14 along the direction S₇, a quick zoom-out command for the specific region 28 could be accordingly executed on the on the operating interface 26. As for the pressure-value calculation of the processing unit 20 and the other related description, they could be reasoned according to the aforesaid embodiment and therefore omitted herein.

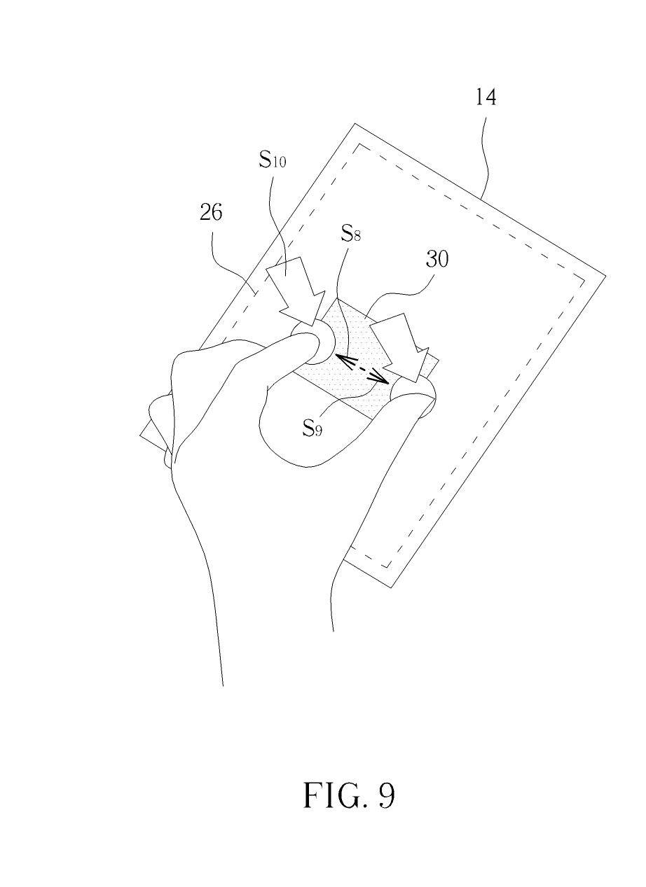

The design of utilizing the aforesaid pressure-sensing touch method to execute a copy command or a mark command for a specific region is described as follows. Please refer to FIG. 9, which is a diagram of performing a region selecting operation for a specific region on the touch panel 14 in FIG. 1 according to another embodiment of the present invention. First, the user could touch two points of the touch panel 14 as shown in FIG. 9 and then perform a two-point outward slide operation along two directions S₈, S₉ to select a specific region 30, so as to execute a region selecting command (could be regarded as the first touch command) on the operating interface 26. Subsequently, the user could exert force on the touch panel 14 along a direction S₁₀, so as to further execute a copy command or a mark command (could be regarded as the second touch command) for the specific region 30 on the operating interface 26. As for the pressure-value calculation of the processing unit 20 and the other related description, they could be reasoned according to the aforesaid embodiment and therefore omitted herein.

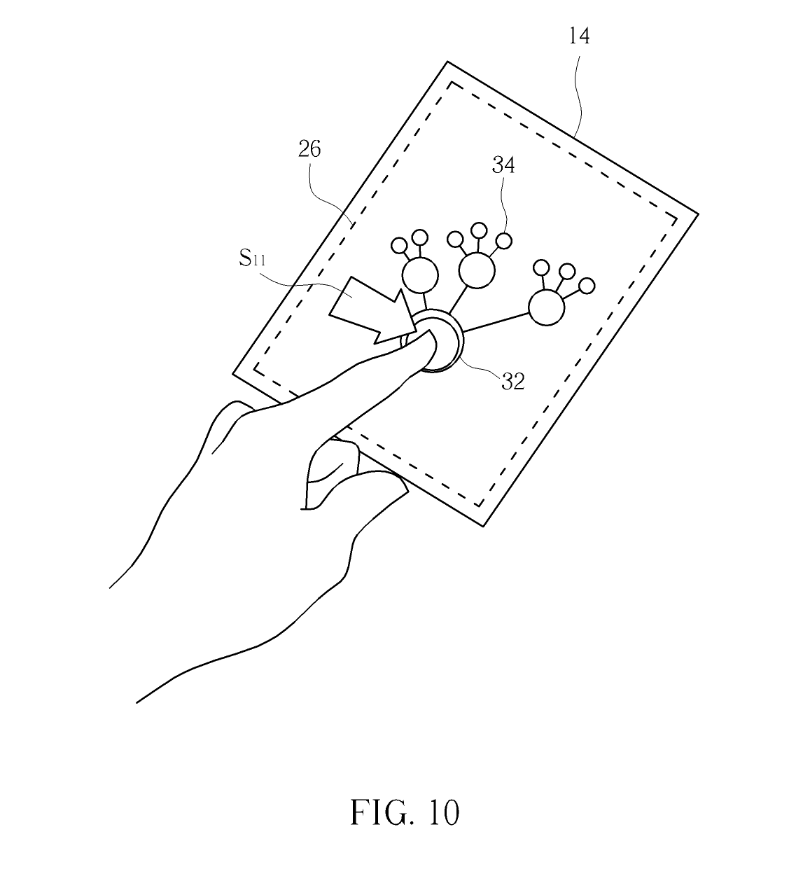

The design of utilizing the aforesaid pressure-sensing touch method to execute a menu display command for a function icon is described as follows. Please refer to FIG. 10, which is a diagram of performing a function-icon clicking operation on the touch panel 14 in FIG. 1 according to another embodiment of the present invention. First, the user could touch a function icon 32 on the operating interface 26 as shown in FIG. 10, so as to execute a function-icon clicking command (could be regarded as the first touch command) on the operating interface 26. Subsequently, the user could exert force on the touch panel 14 along a direction S₁₁, so as to further execute a menu display command (could be regarded as the second touch command) for the function icon 32 to display a function menu 34 corresponding to the function icon 32 on the operating interface 26. As for the pressure-value calculation of the processing unit 20 and the other related description, they could be reasoned according to the aforesaid embodiment and therefore omitted herein.

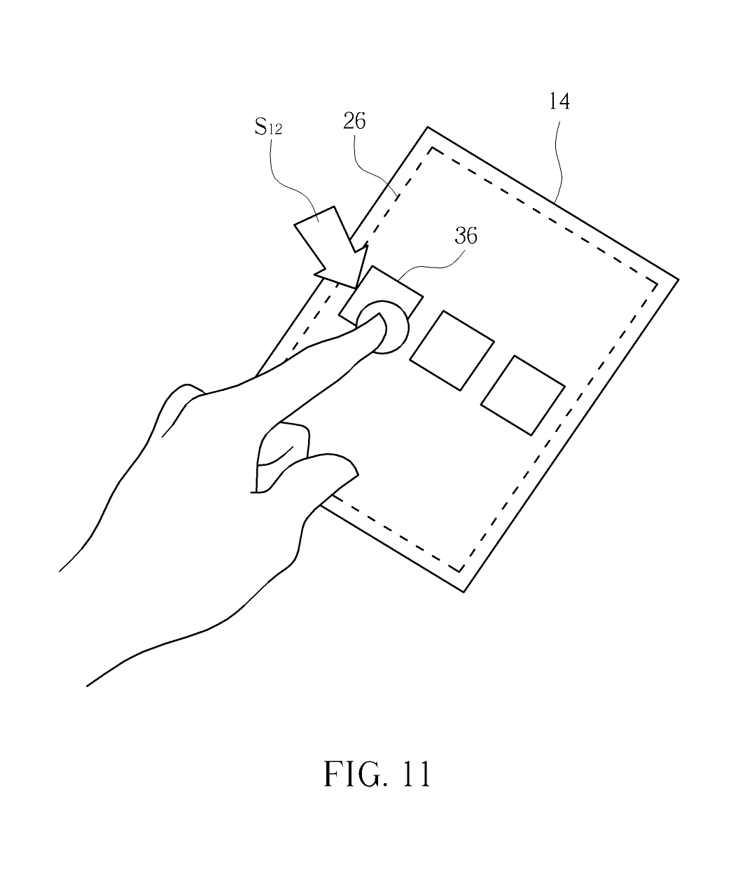

The design of utilizing the aforesaid pressure-sensing touch method to execute an icon processing command for a function icon is described as follows. Please refer to FIG. 11, which is a diagram of performing a function-icon clicking operation on the touch panel 14 in FIG. 1 according to another embodiment of the present invention. First, the user could touch a function icon 36 on the operating interface 26 as shown in FIG. 11, so as to execute a function-icon clicking command (could be regarded as the first touch command) on the operating interface 26. Subsequently, the user could exert force on the touch panel 14 along a direction S₁₂, so as to further execute an icon processing command (could be regarded as the second touch command) for the function icon 36, such as an icon dragging command or an icon deleting command. As for the pressure-value calculation of the processing unit 20 and the other related description, they could be reasoned according to the aforesaid embodiment and therefore omitted herein.

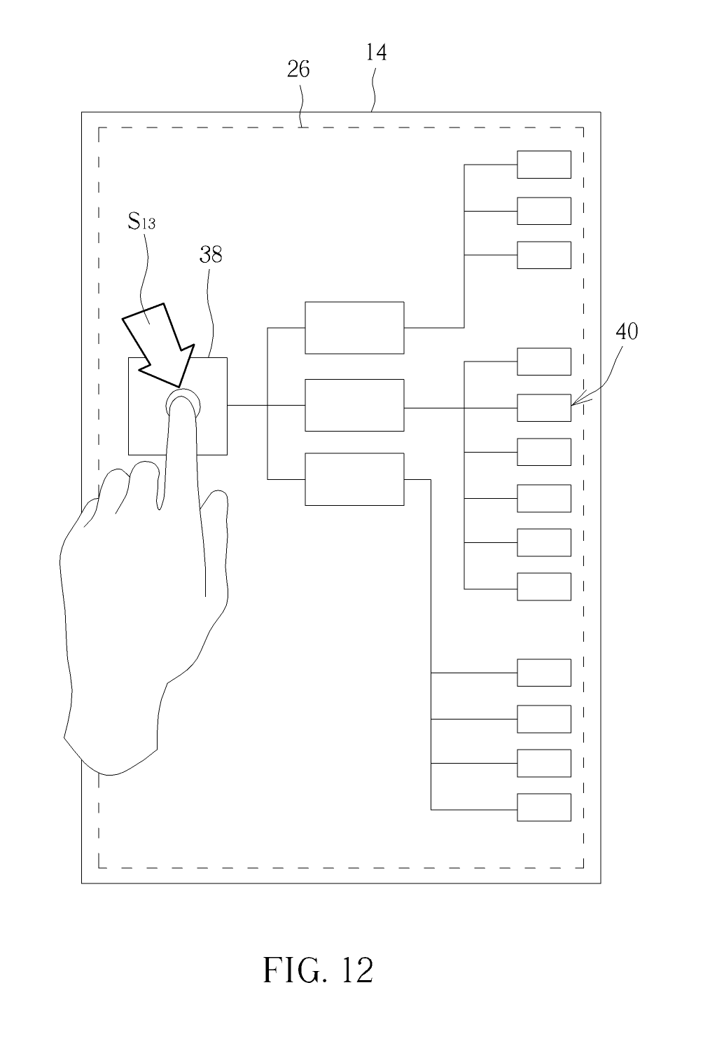

The design of utilizing the aforesaid pressure-sensing touch method to execute a directory expanding command for a folder icon is described as follows. Please refer to FIG. 12, which is a diagram of performing a folder-icon clicking operation on the touch panel 14 in FIG. 1 according to another embodiment of the present invention. First, the user could touch a folder icon 38 on the operating interface 26 as shown in FIG. 12, so as to execute a folder-icon clicking command (could be regarded as the first touch command) on the operating interface 26. Subsequently, the user could exert force on the touch panel 14 along a direction S₁₃, so as to further execute a directory expanding command (could be regarded as the second touch command) for the folder icon 38 to expand a directory 40 (e.g. a parent directory or a subdirectory) corresponding to the folder icon 38 on the operating interface 26. As for the pressure-value calculation of the processing unit 20 and the other related description, they could be reasoned according to the aforesaid embodiment and therefore omitted herein.

It should be mentioned that number of the pressure-sensing strips is not limited to four but varies with the practical application of the touch display device 10. That is to say, all designs of utilizing at least one pressure-sensing strip to detect a pressure value that the touch panel withstands and then executing a further touch command according to the detected pressure value may fall within the scope of the present invention. For example, in another embodiment, the pressure-sensing device 15 could include only one pressure-sensing strip 16 disposed at a position corresponding to a side of the touch panel 14. As for other related description and the derived embodiments, they could be reasoned according to the aforesaid embodiments and therefore omitted herein. To be noted, in the aforesaid design that the pressure-sensing device 15 includes only one pressure-sensing strip 16, the touch display device 10 could utilize a weighted calculating equation to calculate a pressure weighted value, such as calculating the pressure weighted value according to the distance relationship between the coordinate value corresponding to the touch operation and the pressure-sensing strip 16.

In summary, the present invention utilizes the design of executing a further touch command according to the pressure value detected by the pressure-sensing device to replace the prior art design in which a user needs to press the touch panel over a period of time for executing a further touch command. In such a manner, the present invention could not only reduce time needed for performing touch operations on the touch panel of the touch display device, but also make the touch operations of the touch display device more intuitive and convenient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pressure-sensing touch method applied to a touch display device, the touch display device comprising a touch panel, a display panel, a pressure-sensing device, an analogy-to-digital converter and a processing unit, the touch panel being disposed on the display panel, the pressure-sensing device being disposed at a position corresponding to at least one side of the touch panel, the display panel being used for displaying an operating interface, the analogy-to-digital converter being electrically connected to the pressure-sensing device, the processing unit being electrically connected to the touch panel, the display panel, and the analogy-to-digital converter, the pressure-sensing touch method comprising:
performing a touch operation on the touch panel;
the processing unit executing a first touch command on an operating interface according to the touch operation;
the touch panel detecting a coordinate value corresponding to the touch operation;
the pressure-sensing device detecting at least one pressure value corresponding to the coordinate value on the touch panel;
the analogy-to-digital converter performing analogy-to-digital conversion on the pressure value detected by the pressure-sensing device; and
the processing unit determining whether to execute a second touch command according to the coordinate value and the pressure value detected by the pressure-sensing device.

2. The pressure-sensing touch method of claim 1, wherein the pressure-sensing device comprises four pressure-sensing strips, performing the touch operation on the touch panel comprises performing a slide operation or a click operation on the touch panel, and the processing unit determining whether to execute the second touch command according to the coordinate value and the pressure value detected by the pressure-sensing device comprises:
the processing unit calculating a pressure average value according to the coordinate value and the pressure value detected by each pressure-sensing strip; and
the processing unit determining whether to execute the second touch command according to the pressure average value.

3. The pressure-sensing touch method of claim 2, wherein performing the slide operation on the touch panel comprises performing a one-point slide operation on the touch panel, and the processing unit determining whether to execute the second touch command according to the pressure average value comprises:
the processing unit executing an unlock command or a quick scroll command on the operating interface when the processing unit determines that the pressure average value is greater than or equal to a threshold value.

4. The pressure-sensing touch method of claim 3, wherein the touch panel has a plurality of touch regions, and the processing unit calculating the pressure average value according to the coordinate value and the pressure value detected by each pressure-sensing strip comprises:
when the touch region where the coordinate value is located is adjacent to one of the pressure-sensing strips, the pressure average value is calculated according to the following equation:
the pressure average value=the pressure value detected by the adjacent pressure-sensing strip;
when the touch region where the coordinate value is located is adjacent to two of the pressure-sensing strips, the pressure average value is calculated according to the following equation:
the pressure average value=(the sum of the two pressure value detected by the two adjacent pressure-sensing strips)/2; and
when the touch region where the coordinate value is located is not adjacent to the pressure-sensing strips, the pressure average value is calculated according to the following equation: the pressure average value=(the sum of the pressure value detected by each pressure-sensing strip)/4.

5. The pressure-sensing touch method of claim 3 further comprising:
the processing unit controlling the display device to display a tooltip indicating a measure of the pressure average value on the operating interface.

6. The pressure-sensing touch method of claim 2, wherein performing the slide operation on the touch panel comprises performing a two-point slide operation on the touch panel to select a specific region, and the processing unit determining whether to execute the second touch command according to the pressure average value comprises:
when the processing unit determines the pressure average value is greater than or equal to a threshold value, the processing unit executes a quick zoom-in command, a quick zoom-out command, a copy command, or a mark command corresponding to the specific region on the operating interface.

7. The pressure-sensing touch method of claim 6, wherein the touch panel has a plurality of touch regions, and the processing unit calculating the pressure average value according to the coordinate value and the pressure value detected by each pressure-sensing strip comprises:
when the touch region where the coordinate value is located is adjacent to one of the pressure-sensing strips, the pressure average value is calculated according to the following equation: the pressure average value=the pressure value detected by the adjacent pressure-sensing strip;
when the touch region where the coordinate value is located is adjacent to two of the pressure-sensing strips, the pressure average value is calculated according to the following equation: the pressure average value=(the sum of the two pressure value detected by the two adjacent pressure-sensing strips)/2; and
when the touch region where the coordinate value is located is not adjacent to the pressure-sensing strips, the pressure average value is calculated according to the following equation: the pressure average value=(the sum of the pressure value detected by each pressure-sensing strip)/4.

8. The pressure-sensing touch method of claim 2, wherein the operating interface has a function icon, performing the click operation on the touch panel comprises clicking the function icon on the touch panel, and the processing unit determining whether to execute the second touch command according to the pressure average value comprises:
when the processing unit determines the pressure average value is greater than or equal to a threshold value, the processing unit executes a menu display command or an icon processing command corresponding to the function icon on the operating interface.

9. The pressure-sensing touch method of claim 8, wherein the touch panel has a plurality of touch regions, and the processing unit calculating the pressure average value according to the coordinate value and the pressure value detected by each pressure-sensing strip comprises:
when the touch region where the coordinate value is located is adjacent to one of the pressure-sensing strips, the pressure average value is calculated according to the following equation: the pressure average value=the pressure value detected by the adjacent pressure-sensing strip;
when the touch region where the coordinate value is located is adjacent to two of the pressure-sensing strips, the pressure average value is calculated according to the following equation: the pressure average value=(the sum of the two pressure value detected by the two adjacent pressure-sensing strips)/2; and
when the touch region where the coordinate value is located is not adjacent to the pressure-sensing strips, the pressure average value is calculated according to the following equation: the pressure average value=(the sum of the pressure value detected by each pressure-sensing strip)/4.

10. The pressure-sensing touch method of claim 8, wherein the icon processing command comprises an icon dragging command or an icon deleting command.

11. The pressure-sensing touch method of claim 2, wherein the operating interface has a folder icon, performing the click command on the touch panel comprises clicking the folder icon on the touch panel, and the processing unit determining whether to execute the second touch command according to the pressure average value comprises:
when the processing unit determines the pressure average value is greater than or equal to a threshold value, the processing unit executes a directory expanding command corresponding to the folder icon on the operating interface.

12. The pressure-sensing touch method of claim 11, wherein the touch panel has a plurality of touch regions, and the processing unit calculating the pressure average value according to the coordinate value and the pressure value detected by each pressure-sensing strip comprises:
when the touch region where the coordinate value is located is adjacent to one of the pressure-sensing strips, the pressure average value is calculated according to the following equation: the pressure average value=the pressure value detected by the adjacent pressure-sensing strip;
when the touch region where the coordinate value is located is adjacent to two of the pressure-sensing strips, the pressure average value is calculated according to the following equation: the pressure average value=(the sum of the two pressure value detected by the two adjacent pressure-sensing strips)/2; and
when the touch region where the coordinate value is located is not adjacent to the pressure-sensing strips, the pressure average value is calculated according to the following equation: the pressure average value=(the sum of the pressure value detected by each pressure-sensing strip)/4.

13. The pressure-sensing touch method of claim 1, wherein the pressure-sensing device comprises a pressure-sensing strip, performing the touch operation on the touch panel comprises performing a slide operation or a click operation, and the processing unit determining whether to execute the second touch command according to the coordinate value and the pressure value detected by the pressure-sensing device comprises:
the processing unit determining whether to execute the second touch command according to the coordinate value and the pressure value detected by the pressure-sensing strip.

14. The pressure-sensing touch method of claim 13, wherein performing the slide operation on the touch panel comprises performing a one-point slide operation on the touch panel, and the processing unit determining whether to execute the second touch command according to the coordinate value and the pressure value comprises:
the processing unit executing an unlock command or a quick scroll command on the operating interface when the processing unit determines that the pressure value is greater than or equal to a threshold value.

15. The pressure-sensing touch method of claim 14 further comprising:
the processing unit controlling the display device to display a tooltip indicating a measure of the pressure value on the operating interface.

16. The pressure-sensing touch method of claim 13, wherein performing the slide operation on the touch panel comprises performing a two-point slide operation on the touch panel to select a specific region, and the processing unit determining whether to execute the second touch command according to the coordinate value and the pressure value comprises:
when the processing unit determines the pressure value is greater than or equal to a threshold value, the processing unit executes a quick zoom-in command, a quick zoom-out command, a copy command, or a mark command corresponding to the specific region on the operating interface.

17. The pressure-sensing touch method of claim 13, wherein the operating interface has a function icon, performing the click operation on the touch panel comprises clicking the function icon on the touch panel, and the processing unit determining whether to execute the second touch command according to the coordinate value and the pressure value comprises:
when the processing unit determines the pressure value is greater than or equal to a threshold value, the processing unit executes a menu display command or an icon processing command corresponding to the function icon on the operating interface.

18. The pressure-sensing touch method of claim 17, wherein the icon processing command comprises an icon dragging command or an icon deleting command.

19. The pressure-sensing touch method of claim 13, wherein the operating interface has a folder icon, performing the click command on the touch panel comprises clicking the folder icon on the touch panel, and the processing unit determining whether to execute the second touch command according to the coordinate value and the pressure value comprises:
when the processing unit determines the pressure value is greater than or equal to a threshold value, the processing unit executes a directory expanding command corresponding to the folder icon on the operating interface.

20. A touch display device comprising:
a display panel for displaying an operating interface of an operating system;
a touch panel disposed on the display panel for detecting a coordinate value corresponding to a touch operation;
a pressure-sensing device disposed at a position corresponding to at least one side of the touch panel for detecting at least one pressure value corresponding to the coordinate value on the touch panel;
an analogy-to-digital converter electrically connected to the pressure-sensing device for performing analogy-to-digital conversion on the pressure value detected by the pressure-sensing device;
a processing unit electrically connected to the touch panel, the display panel, and the analogy-to-digital converter for executing a first touch command on the operating interface and for determining whether to execute a second touch command according to the coordinate value and the pressure value detected by the pressure-sensing device; and
a storage unit electrically connected to the processing unit for storing the operating system and the pressure value detected by the pressure-sensing device.

21. The touch display device of claim 20, wherein the pressure-sensing device comprises four pressure-sensing strips respectively disposed at positions corresponding to four sides of the touch panel, the touch operation comprises a slide operation or a click operation, and the processing unit is used for calculating a pressure average value according to the coordinate value and the pressure value detected by each pressure-sensing strip and for determining whether to execute the second touch command according to the pressure average value.

22. The touch display device of claim 21, wherein the slide operation comprises a one-point slide operation, and the processing unit is used for controlling the operating system to call a corresponding application program interface so as to execute an unlock command or a quick scroll command on the operating interface when the processing unit determines that the pressure average value is greater than or equal to a threshold value.

23. The touch display device of claim 22, wherein the touch panel has a plurality of touch regions; when the touch region where the coordinate value is located is adjacent to one of the pressure-sensing strips, the pressure average value is calculated according to the following equation: the pressure average value=the pressure value detected by the adjacent pressure-sensing strip; when the touch region where the coordinate value is located is adjacent to two of the pressure-sensing strips, the pressure average value is calculated according to the following equation: the pressure average value=(the sum of the two pressure value detected by the two adjacent pressure-sensing strips)/2; when the touch region where the coordinate value is located is not adjacent to the pressure-sensing strips, the pressure average value is calculated according to the following equation: the pressure average value=(the sum of the pressure value detected by each pressure-sensing strip)/4.

24. The touch display device of claim 22, wherein the processing unit is further used for controlling the operating system to call a corresponding application program interface so that the display device could display a tooltip indicating a measure of the pressure average value on the operating interface.

25. The touch display device of claim 21, wherein the slide operation comprises a two-point slide operation to select a specific region on the touch panel, and when the processing unit determines the pressure average value is greater than or equal to a threshold value, the processing unit is used for controlling the operating system to call a corresponding application program interface so as to execute a quick zoom-in command, a quick zoom-out command, a copy command, or a mark command corresponding to the specific region on the operating interface.

26. The touch display device of claim 25, wherein the touch panel has a plurality of touch regions; when the touch region where the coordinate value is located is adjacent to one of the pressure-sensing strips, the pressure average value is calculated according to the following equation: the pressure average value=the pressure value detected by the adjacent pressure-sensing strip; when the touch region where the coordinate value is located is adjacent to two of the pressure-sensing strips, the pressure average value is calculated according to the following equation: the pressure average value=(the sum of the two pressure value detected by the two adjacent pressure-sensing strips)/2; when the touch region where the coordinate value is located is not adjacent to the pressure-sensing strips, the pressure average value is calculated according to the following equation: the pressure average value=(the sum of the pressure value detected by each pressure-sensing strip)/4.

27. The touch display device of claim 21, wherein the operating interface has a function icon, the click operation comprises clicking the function icon on the touch panel, and when the processing unit determines the pressure average value is greater than or equal to a threshold value, the processing unit is used for controlling the operating system to call a corresponding application program interface so as to execute a menu display command or an icon processing command corresponding to the function icon on the operating interface.

28. The touch display device of claim 27, wherein the touch panel has a plurality of touch regions; when the touch region where the coordinate value is located is adjacent to one of the pressure-sensing strips, the pressure average value is calculated according to the following equation: the pressure average value=the pressure value detected by the adjacent pressure-sensing strip; when the touch region where the coordinate value is located is adjacent to two of the pressure-sensing strips, the pressure average value is calculated according to the following equation: the pressure average value=(the sum of the two pressure value detected by the two adjacent pressure-sensing strips)/2; when the touch region where the coordinate value is located is not adjacent to the pressure-sensing strips, the pressure average value is calculated according to the following equation: the pressure average value=(the sum of the pressure value detected by each pressure-sensing strip)/4.

29. The touch display device of claim 27, wherein the icon processing command comprises an icon dragging command or an icon deleting command.

30. The touch display device of claim 21, wherein the operating interface has a folder icon, the click command comprises clicking the folder icon on the touch panel, and when the processing unit determines the pressure average value is greater than or equal to a threshold value, the processing unit is used for controlling the operating system to call a corresponding application program interface so as to execute a directory expanding command corresponding to the folder icon on the operating interface.

31. The touch display device of claim 30, wherein the touch panel has a plurality of touch regions; when the touch region where the coordinate value is located is adjacent to one of the pressure-sensing strips, the pressure average value is calculated according to the following equation: the pressure average value=the pressure value detected by the adjacent pressure-sensing strip; when the touch region where the coordinate value is located is adjacent to two of the pressure-sensing strips, the pressure average value is calculated according to the following equation: the pressure average value=(the sum of the two pressure value detected by the two adjacent pressure-sensing strips)/2; when the touch region where the coordinate value is located is not adjacent to the pressure-sensing strips, the pressure average value is calculated according to the following equation: the pressure average value=(the sum of the pressure value detected by each pressure-sensing strip)/4.

32. The touch display device of claim 20, wherein the pressure-sensing device comprises a pressure-sensing strip, the touch operation comprises a slide operation or a click operation, and the processing unit is used for determining whether to execute the second touch command according to the coordinate value and the pressure value detected by the pressure-sensing strip.

33. The touch display device of claim 32, wherein the slide operation comprises a one-point slide operation on the touch panel, and when the processing unit determines that the pressure value is greater than or equal to a threshold value, the processing unit is used for controlling the operating system to call a corresponding application program interface so as to execute an unlock command or a quick scroll command on the operating interface.

34. The touch display device of claim 33, wherein the processing unit is further used for controlling the operating system to call a corresponding application program so that the display device could display a tooltip indicating a measure of the pressure value on the operating interface.

35. The touch display device of claim 32, wherein the slide operation comprises a two-point slide operation to select a specific region on the touch panel, and when the processing unit determines the pressure value is greater than or equal to a threshold value, the processing unit is used for controlling the operating system to call a corresponding application program interface so as to execute a quick zoom-in command, a quick zoom-out command, a copy command, or a mark command corresponding to the specific region on the operating interface.

36. The touch display device of claim 32, wherein the operating interface has a function icon, the click operation comprises clicking the function icon on the touch panel, and when the processing unit determines the pressure value is greater than or equal to a threshold value, the processing unit is used for controlling the operating system to call a corresponding application program interface so as to execute a menu display command or an icon processing command corresponding to the function icon on the operating interface.

37. The touch display device of claim 36, wherein the icon processing command comprises an icon dragging command or an icon deleting command.

38. The touch display device of claim 32, wherein the operating interface has a folder icon, the click command comprises clicking the folder icon on the touch panel, and when the processing unit determines the pressure value is greater than or equal to a threshold value, the processing unit is used for controlling the operating system to call a corresponding application program interface so as to execute a directory expanding command corresponding to the folder icon on the operating interface.
